(19) United States
(12) Patent Application Publication
(10) Pub. No.: US 2013/0214779 A1
(43) Pub. Date: Aug. 22, 2013

(54) METHOD AND SYSTEM TO CHARACTERIZE A PROPERTY OF AN EARTH FORMATION

(71) Applicants: Holger Tietjen, Hannover (DE); Mouin Hamdan, Celle (DE)

(72) Inventors: Holger Tietjen, Hannover (DE); Mouin Hamdan, Celle (DE)

(73) Assignee: Baker Hughes Incorporated, Houston, TX (US)

(21) Appl. No.: 13/764,862

(22) Filed: Feb. 12, 2013

Related U.S. Application Data
(60) Provisional application No. 61/601,721, filed on Feb. 22, 2012.

(51) Int. Cl. G01V 3/38; G06F 17/11; G01V 3/14

(52) U.S. Cl. CPC G01V 3/38; G01V 3/14; G06F 17/11
USPC 324/303; 702/8

(57) ABSTRACT

A system and method of characterizing a property of an earth formation penetrated by a borehole are described. The method includes conveying a carrier through the borehole. The method also includes performing an NMR measurement with an NMR tool disposed at the carrier and obtaining NMR data, compressing the NMR data to generate compressed NMR data, and telemetering the compressed NMR data to a surface processor for processing. The method further includes decompressing the compressed NMR data directly to T₁ or T₂ domain distribution data, and determining the property of the earth formation based on the T₁ or T₂ domain distribution data.

### CROSS-REFERENCE TO RELATED APPLICATION

This application is a Non-Provisional of U.S. Provisional Patent Application No. 61/601,721 filed Feb. 22, 2012, the disclosure of which is incorporated by reference herein in its entirety.

### BACKGROUND OF THE INVENTION

Geologic formations are used for many purposes such as hydrocarbon production, geothermal production and carbon dioxide sequestration. In general, formations are characterized in order to determine whether the formations are suitable for their intended purpose.

One way to characterize a formation is to convey a downhole tool through a borehole penetrating the formation. The tool is configured to perform measurements of one or more properties of the formation at various depths in the borehole to create a measurement log. Many types of logs can be used to characterize a formation. One type of downhole tool that can determine various properties of a formation is a nuclear magnetic resonance (NMR) tool. NMR tools may generate a static magnetic field in a sensitive volume surrounding the wellbore or may use the earth's magnetic field rather than generating a magnetic field. NMR is based on the fact that the nuclei of many elements have angular momentum (spin) and a magnetic moment. The nuclei have a characteristic Larmor resonant frequency related to the magnitude of the magnetic field in their locality. Over time the nuclear spins align themselves in part along an externally applied magnetic field, resulting in an equilibrium macroscopic nuclear magnetization. This equilibrium situation can be disturbed by a pulse of a magnetic field oscillating at the Larmor frequency, which tips the magnetization within the bandwidth of the oscillating magnetic field away from the static field direction.

After tipping, the magnetization precesses around the static field at a particular frequency known as the Larmor frequency. At the same time, the magnetization returns to the equilibrium direction (i.e., aligned with the static field) according to a characteristic relaxation time known as the spin-lattice relaxation time or T₁.

At the end of a θ=90° tipping pulse (also referred to as an excitation pulse), the magnetization points in a common direction perpendicular to the static field and then precesses at the Larmor frequency. However, because of inhomogeneity in the static field due to the constraints on tool shape, imperfect instrumentation, or microscopic material heterogeneities, each nuclear spin precesses at a slightly different rate. Hence, after a time long compared to the precession period, but shorter than T₁, the spins will no longer be precessing in phase. This de-phasing occurs with a time constant that is commonly referred to as T₂*. In downhole applications, T₂^{*} is mainly due to the non-uniformity of the static magnetic field. T₂* is often so short that the NMR signal that forms right after the tipping pulse is undetectable. It is, however, possible to rephase the spins by using so-called rephasing or refocusing pulses to generate a sequence of spin echoes. The standard pulse echo sequence for doing this is the Carr-Purcell-Meiboom-Gill (CPMG) sequence. The decay of the amplitudes of the spin echoes occurs with the spin-spin relaxation time T₂ and is due to properties of the material. Hence, a CPMG consists of one excitation pulse followed by a plurality of refocusing pulses, with the decaying NMR echoes forming between the refocusing pulses.

The NMR tool includes a receiving coil designed so that a voltage is induced by the precessing spins. Only that component of the nuclear magnetization that is precessing in the plane perpendicular to the static field is sensed by the coil. Signals received by the receiving coil are referred to as NMR signals and these signals are used to determine properties of the formation in the sensitive volume. NMR signals at the present time are used to determine porosity, hydrocarbon saturation, and permeability of rock formations.

The NMR signals can be telemetered to the surface for processing to determine the formation properties of interest. For example, mud pulse telemetry involves pulsing the mud used in the drilling process to convey the NMR signal information. One challenge presented by downhole telemetry systems, like mud pulse telemetry, is the limited bandwidth. As a result, compression of data downhole and subsequent decompression of the data at the surface are integral to formation characterization via tools like the NMR tools, and improved telemetering methods would be appreciated in the drilling industry.

### BRIEF SUMMARY

According to one aspect of the invention, a method of characterizing a property of an earth formation penetrated by a borehole includes conveying a carrier through the borehole; performing an NMR measurement with an NMR tool disposed at the carrier and obtaining NMR data; compressing the NMR data to generate compressed NMR data; telemetering the compressed NMR data to a surface processor for processing; decompressing the compressed NMR data directly to T1 or T2 domain distribution data; and determining the property of the earth formation based on the T1 or T2 domain distribution data.

According to another aspect of the invention, a system to characterize a property of an earth formation penetrated by a borehole includes an NMR tool disposed in the borehole and configured to perform an NMR measurement to obtain NMR data; a first processor configured to compress the NMR data to generate compressed NMR data; and a second processor disposed at an uphole location, the second processor configured to receive the compressed NMR data and decompress the compressed NMR data directly to T₁ or T₂ domain distribution data.

According to yet another aspect of the invention, a computer-readable medium is configured to store instructions which, when processed by a processor, cause the processor to perform a method of characterizing a property of an earth formation penetrated by a borehole. The method includes receiving compressed NMR data generated by compressing NMR data obtained by an NMR tool disposed at a carrier conveyed through the borehole; decompressing the compressed NMR data directly to T₁ or T₂ domain distribution data according to:

Comp_{1×m}×Scores_{k×m}^{t}×(Scores_{k×m}×Scores_{k×m}^{t})⁻¹=A_{1×k}×I_{k×k}

where Comp is the compressed NMR data, A represents the T₁ or T₂ domain distribution data, I is an identity matrix, and Scores are scale vectors of each Principle Component, based on Principle Component Analysis (PCA), of a matrix that spans all single component decays in an echo train space of the NMR data; and determining the property of the earth formation based on the T₁ or T₂ domain distribution data.

### BRIEF DESCRIPTION OF THE DRAWINGS

Referring now to the drawings wherein like elements are numbered alike in the several Figures:

FIG. 1 illustrates a cross-sectional view of an exemplary embodiment of a nuclear magnetic resonance (NMR) tool disposed in a borehole penetrating the earth, which includes an earth formation;

FIG. 2 illustrates the processes 200 included in acquiring and processing NMR data according to the prior art;

FIG. 3 illustrates the processes 300 included in acquiring and processing NMR data according to an embodiment of the invention;

FIG. 4 illustrates exemplary T₂ domain distribution data, recovered by direct decompression according to an embodiment of the invention; and

FIG. 5 illustrates exemplary T₁ domain distribution data, recovered by direct decompression according to an embodiment of the invention.

### DETAILED DESCRIPTION

A detailed description of one or more embodiments of the disclosed apparatus and method presented herein by way of exemplification and not limitation with reference to the Figures.

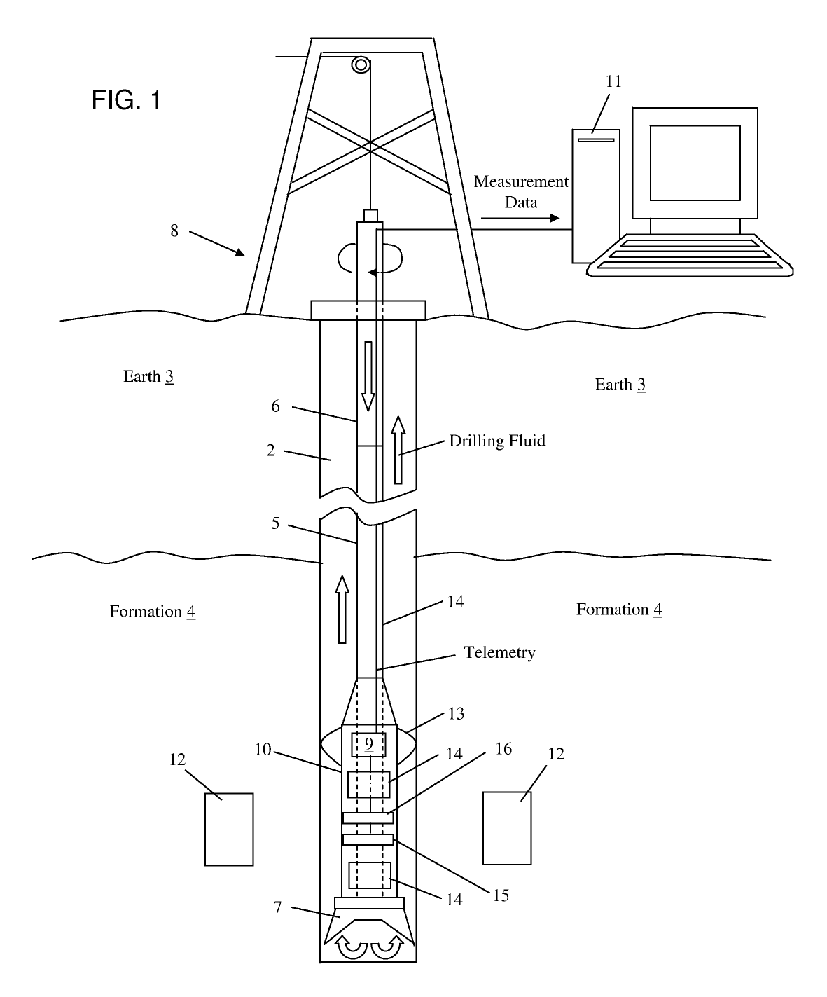

FIG. 1 illustrates a cross-sectional view of an exemplary embodiment of a nuclear magnetic resonance (NMR) tool 10 disposed in a borehole 2 penetrating the earth 3, which includes an earth formation 4. The formation 4 represents any subsurface material of interest. The NMR tool 10 is conveyed through the borehole 2 by a carrier 5. In the embodiment of FIG. 1, the carrier 5 is a drill string 6 in an embodiment known as logging-while-drilling (LWD). Disposed at a distal end of the drill string 6 is a drill bit 7. A drilling rig 8 is configured to conduct drilling operations such as rotating the drill string 6 and thus the drill bit 7 in order to drill the borehole 2. In addition, the drilling rig 8 is configured to pump drilling fluid through the drill string 6 in order to lubricate the drill bit 7 and flush cuttings from the borehole 2. In one or more embodiments, a stabilizer 13 may be used to limit lateral movement of the NMR tool 10 in the borehole 2. Downhole electronics 9 are configured to operate the NMR tool 10 and/or process measurements or data received from the tool 10. Telemetry is used to provide communications between the NMR tool 10 and a computer processing system 11 disposed at the surface of the earth 3. NMR data processing or operations can also be performed by the computer processing system 11 in addition to or in lieu of the downhole electronics 9. As noted above, this telemetry, by mud pulse, for example, may present a challenge by providing limited bandwidth.

The NMR tool 10 includes NMR components configured to perform NMR measurements on a sensitive volume 12 in the formation 4. The sensitive volume 12 has a generally toroidal shape surrounding the borehole 2. The NMR components include an arrangement of magnets 14 that is configured to generate a static magnetic field having a decreasing field strength or magnitude with increasing radial distance from the NMR tool in the sensitive volume 12. A radio frequency (RF) coil 15 or antenna is used to produce pulsed RF fields substantially orthogonal to the static field in the sensitive volume 12. The nuclear spins in the sensitive volume 12 align themselves partly along the static magnetic field, applied by the magnets 14, forming a macroscopic nuclear magnetization. A pulsed RF field is applied to tip the nuclear magnetization into the transverse plane, resulting in a precession of the magnetization. Such a tipping pulse is followed by a series of refocusing pulses and the resulting series of pulse echoes (also referred to as an echo train, spin echoes, or NMR signals) is detected by a receiver coil 16 or antenna. The pulse sequences may be in the form of a Carr-Purcell-Meiboom-Gill (CPMG) sequence or, alternatively, an optimized rephasing pulse sequence (ORPS). ORPS is similar to CPMG but the pulse widths are optimized for the actual field distributions of the static and alternating fields. The alternative sequence may be used to maximize signal and minimize RF power consumption. The NMR signals include a longitudinal relaxation time constant (referred to as T₁) and a transverse relaxation time constant (referred to as T₂). The term “relaxation” relates to the nuclear magnetization precessing towards equilibrium.

The NMR signals (echo train) are compressed prior to being telemetered to the surface for processing by the computer processing system 11. The compression process is detailed below. In prior art systems, the compressed echo train was decompressed to recover the echo train sequence and then inverted into the T₁ or T₂ domain distribution in order to obtain the formation characteristic of interest. Embodiments of the invention provide for decompressing directly into the T₁ or T₂ domain distributions, as also detailed below.

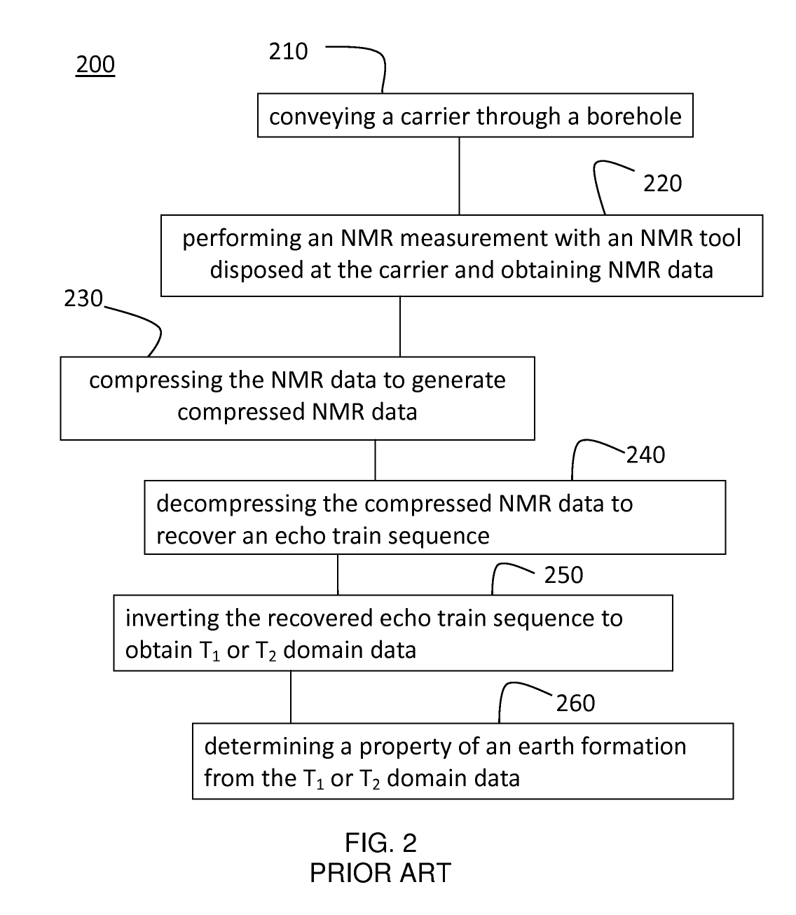

FIG. 2 illustrates the processes 200 included in acquiring and processing NMR data according to the prior art. As shown, the processes include conveying a carrier 5 through a borehole at 210, performing an NMR measurement with an NMR tool 10 disposed at the carrier 5 and obtaining NMR data at 220. The NMR data is an echo train sequence, and the processes include compressing the NMR data to generate compressed NMR data at 230. In an exemplary downhole application, the compressed echo train sequence may then be telemetered to an uphole location for processing. The term uphole relates to a location at or above the earth's surface or in the borehole at a location closer to the earth's surface. At 240, the decompressing process includes decompressing the compressed NMR data to recover an echo train sequence as a first step, and inverting the recovered echo train sequence to obtain T₁ or T2 domain distribution data at 250. The multiple steps are needed for determining a property of an earth formation 4 from the T₁ or T₂ domain distribution data at 260.

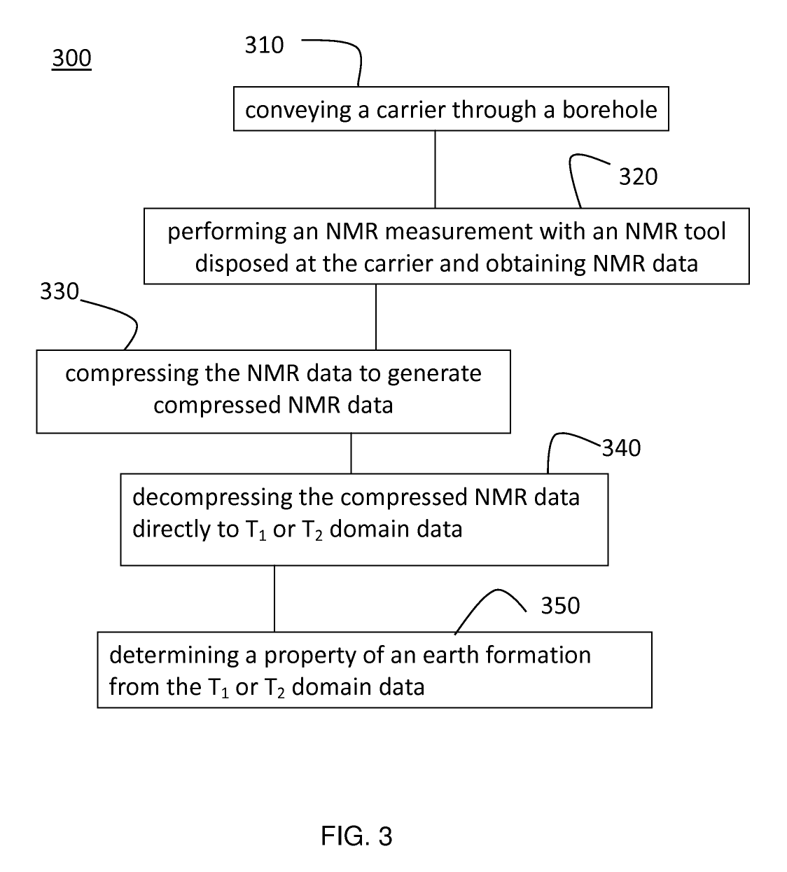

FIG. 3 illustrates the processes 300 included in acquiring and processing NMR data according to an embodiment of the invention. As shown, the processes include conveying a carrier 5 through a borehole at 310. As shown at FIG. 1, the NMR tool 10 is disposed at the carrier 5, and the processes include performing an NMR measurement with an NMR tool 10 disposed at the carrier 5 and obtaining NMR data at 320. The NMR data obtained at 320 may be T₁, T₂, and/or an echo train sequence. At 330, the processes include compressing the NMR data to generate compressed NMR data, as detailed below. However, unlike the prior art, the processes include decompressing the compressed NMR data directly to T₁ or T₂ domain distribution data at 340, and, at 350, determining a property of an earth formation 4 from the T₁ or T₂ domain distribution data. The processes 340 and 350 may be performed uphole based on telemetering the compressed NMR data. The direct decompression at 340 is done instead of decompressing to recover the echo train or a T₁ buildup sequence and then inverting to obtain T₁ or T₂ domain distribution data, respectively, as in 240 and 250 of the prior art FIG. 2. The compression and decompression algorithms processed using one or more memory devices and one or more processors of the downhole electronics 9 and the computer processing system 11 are detailed below.

NMR signals, compression, and decompression are now detailed. Direct decompression into the T₂ domain distribution is detailed first and is followed by details related to direct decompression into the T₁ domain. NMR relaxation of fluids in rocks exhibits multi-exponential behavior, which can be expressed in a discrete model as follows:

$$M ( t ) = {\sum }_{j} {A}_{j} {e}^{( \frac{- t}{T {2}_{j}} )} \qquad [ EQ 1 ]$$

Assuming bins T₂ⱼ=0.2 . . . 8192 using increment of 2^{(1/4)}, then T₂ will have a length of 64 bins that are scaled by the T₂ distribution.

This translates into matrix notation when sampling the t at transverse pulse period TE=0.6 milliseconds (ms) and 1000 samples as:

M_{1×1000}=A_{1×64}×F_{64×1000} [EQ 2]

where Aⱼ is proportional to the proton population of pores which have a relaxation time of T₂ⱼ, M(t) is the resultant echo train in continuous time and M is a discretized version of M(t). First, all possible echo trains are mapped with single exponential decay constant into a matrix F. Next, using any orthogonal decomposition technique or, in the present embodiment, through Principal Component Analysis (PCA), the F matrix is decomposed into 2 matrices.

F_{64×1000}=Scores_{64×64}×Loads_{64×1000} [EQ 3]

F is a matrix that spans all single component decays in the echo train space.

Loads is a matrix of eigenvectors of the corresponding type of acquisition (created from Principle Components decomposition of the F matrix). Scores are scale vectors of each Principal Component on matrix F. That is, Scores vectors are projections of those Principal Components (or eigenvectors) onto the matrix F. Scores forms an orthogonal set (Scoresᵢ^{T} Scoresⱼ=0 for i≠j) and Loads forms an orthonormal set (Loadsᵢ^{T} Loadsⱼ=0 for i≠j and =1 for i=j). Therefore, this implies that Loads^{T}=Loads⁻¹. The scores Scoresᵢ^{T} is a linear combination of F defined by Loadsᵢ. That is, Scoresᵢ is the projection of F on Loadsᵢ. By replacing F in EQ 2 with EQ 3:

M_{1×1000}=A_{1×64}×Scores_{64×64}×Loads_{64×1000} [EQ 4]

Let the compression vector (Comp) be:

Comp_{1×64}=A_{1×64}×Scores_{64×64} [EQ 5]

Eqn 4 can then be rewritten as:

M_{1×1000}=Comp_{1×64}×Loads_{64×1000} [EQ 6]

Now, knowing that Loads^{T}=Loads⁻¹ and multiplying both sides of EQ 6 by the inverse of Loads:

M_{1×1000}×Loads^{T}_{1000×64}=Comp_{1×64}×Loads_{64×1000}×Loads^{T}_{1000×64} [EQ 7]

EQ 7 leads to:

M_{1×1000}×Loads^{T}_{1000×64}=Comp_{1×64} [EQ 8]

EQ 8 indicates that an echo train of 1000 points can be compressed into 64 points without losing any information. However, an analysis of PCA indicates that, beyond component 6, there is almost zero percent of variance left. This is shown at Table 1:

TABLE 1
Variance distribution

| | | Value | Cumu- |
|---|---|---|---|
| Principal | Eigenvalue of | of this | lative |
| Component | Covariance(F) | component | variance |
| 1 | 214.0 | 94.3923 | 94.3923 |
| 2 | 10.7 | 4.7247 | 99.1171 |
| 3 | 1.57 | 0.6920 | 99.8091 |
| 4 | 0.327 | 0.1439 | 99.9530 |
| 5 | 0.0790 | 0.0348 | 99.9878 |
| 6 | 0.0203 | 0.0090 | 99.9968 |
| 7 | 0.00537 | 0.0024 | 99.9991 |
| 8 | 0.00142 | 0.0006 | 99.9998 |
| 9 | 0.000376 | 0.0002 | 99.9999 |
| 10 | 0.0000984 | 0.0000 | 100.0000 |
| 11 | 0.00002550 | 0.0000 | 100.0000 |
| 12 | 0.00000651 | 0.0000 | 100.0000 |
| 13 | 0.00000164 | 0.0000 | 100.0000 |
| 14 | 0.00000041 | 0.0000 | 100.0000 |
| 15 | 0.00000010 | 0.0000 | 100.0000 |

As a result of the negligible variance beyond component 6, as shown at

M_{1×1000}×Loads^{T}_{1000×5}=Comp_{1×5} [EQ 9]

or, for high resolution:

M_{1×1000}×Loads^{T}_{1000×6}=Comp_{1×6} [EQ 10]

and EQ 6 becomes, for low resolution:

M_{1×1000}=Comp_{1×5}×Loads_{5×1000} [EQ 11]

or, for high resolution:

M_{1×1000}=Comp_{1×6}×Loads_{6×1000} [EQ 12]

EQ 9 and EQ 10 indicate that providing a reduced form of the Loads matrix allows compression of an echo train of length 1000. Further, with an echo train of length N, a Loads matrix needs to be created as a 5×N into 1×5 matrix for low resolution and as a 6×N into 1×6 matrix for high resolution. Additionally, EQ 11 and EQ 12 indicate that the echo train could be recovered using the same model and the corresponding compression.

In exemplary downhole applications, EQ 9 is used to perform compression downhole when low resolution is selected, and EQ 10 is used when high resolution is selected. Because the forward matrix F is dependent on t and T₂ᵢ, a multitude of F matrices could be used for different t and T₂ binning. That is, a different F matrix must be used if the NMR signal is acquired using a different number of T₂ bins or a different t. In the prior art, once the NMR signal is compressed, EQ 11 and EQ 12 would be used to recover the echo train from the compressed data with reduced dimension. Generally, noise accounts for higher dimensions.

In embodiments of the present invention, the compressed echo train can be used to decompress directly into T₂. Specifically, generalizing EQ 5 to:

Comp_{1×m}=A_{1×k}×Scores_{k×m} [EQ 13]

A (where each A value is proportional to the proton population of pores with corresponding relaxation times T₂) can be recovered directly from the compressed echo train by knowing only the Scores matrix and using the identity matrix I:

Comp_{1×m}×Scores_{k×m}^{t}×(Scores_{k×m}×Scores_{k×m}^{t})⁻¹=A_{1×k}×I_{k×k} [EQ 14]

In fact, if the T₂ distribution were known downhole, EQ 13 could be used to compress it and EQ 14 could be used to decompress T₂ directly. In alternate embodiments that do not require direct decompression into the T₂ domain distribution, EQ 11 could instead be used to decompress the compressed T₂ distribution (using EQ 13) to recover the echo train sequence.

With regard to decompression directly to the T₁ domain distribution rather than to the T₂ domain distribution, EQ 14 would still be used, with Aⱼ being proportional to the proton population of pores which have a longitudinal relaxation time of T₁₁. A more complete discussion of the relevant equations relating to direct decompression to the T₁ domain distribution is provided below:

$$M ( t ) = {\sum }_{j} {A}_{j} ( 1 - {e}^{( \frac{- t}{{T}_{{1}_{j}}} )} ) \qquad [ EQ 15 ]$$

As noted above, Aⱼ is proportional to the proton population of pores which have a longitudinal relaxation time of T₁₁. Here, assuming Tᵢⱼ=0.5 . . . 4096 using an increment of 2^{(1/2)}, then the T₁ distribution will have a length of 29. This will translate into matrix notation when t represents the waiting time TW that goes from 0 to 12000 ms at various steps. Assuming that 30 samples are obtained:

M_{1×30}=A_{1×29}×F_{29×30} [EQ 16]

M(t) is the resultant build up (build up of longitudinal magnetization associated with longitudinal relaxation T₁) in continuous time, and M is the discretized version of M(t). All possible build up rates with single exponential decay constant are mapped into a matrix F. Through Principal Component Analysis (PCA) (or other orthogonal decomposition techniques in alternate embodiments), the F matrix is decomposed into 2 matrices:

F_{29×30}=Scores_{29×29}×Loads_{29×30} [EQ 17]

F is a matrix that spans all single components decays. Loads is a matrix of eigenvectors of the corresponding type of acquisition (created from Principal Components decomposition of the F matrix) and Scores are scale vectors of each Principal Component on matrix F. That is, Scores vectors are projections of those Principal Components (or eigenvectors) onto the matrix F. Scores forms an orthogonal set (Scoresᵢ^{T} Scoresⱼ=0 for i≠j) and Loads forms an orthonormal set (Loadsᵢ^{T} Loadsⱼ=0 for i≠j and =1 for i=j). Therefore, this implies that Loads^{T}=Loads⁻¹. The scores Scores^{T} is a linear combination of F defined by Loadsᵢ. That is, Scoresᵢ is the projection of F on Loadsᵢ.

By replacing F in EQ 16 with EQ 17:

M_{1×30}=A_{1×29}×Scores_{29×29}×Loads_{29×30} [EQ 18]

Let the compression vector (Comp) be:

Comp_{1×29}=A_{1×29}×Scores_{29×29} [EQ 19]

then EQ 18 can be rewritten as:

M_{1×30}=Comp_{1×29}×Loads_{29×30} [EQ 20]

Next, knowing that Loads^{T}=Loads⁻¹, multiplying each side of EQ 20 by the inverse of Loads gives:

M_{1×30}×Loads^{T}_{30×29}=Comp_{1×29}×Loads_{29×30}×Loads^{T}_{30×29} [EQ 21]

then:

M_{1×30}×Loads^{T}_{30×29}=Comp_{1×29} [EQ 22]

EQ 22 indicates that the whole T₁ build up trace can be compressed from 30 points into 29 points without losing any information, but this is clearly insufficient compression given that it permits avoiding transmission of only one point. However, the PCA indicates that, beyond component 6, there is almost zero percent variance left, as shown by Table 2.

TABLE 2
Variance distribution (T₁)

| Principal | | | |
|---|---|---|---|
| Component | Eigenvalue of | % Variance | % Variance |
| (PC) Number | Covariance(F) | Captured This PC | Captured Total |
| 1 | 4.87e+000 | 94.3923 | 87.3888 |
| 2 | 5.61e−001 | 4.7247 | 97.4424 |
| 3 | 1.09e−001 | 0.6920 | 99.3950 |
| 4 | 2.46e−002 | 0.1439 | 99.8369 |
| 5 | 6.49e−003 | 0.0348 | 99.9532 |
| 6 | 1.92e−003 | 0.0090 | 99.9876 |
| 7 | 5.07e−004 | 0.0024 | 99.9967 |
| 8 | 1.58e−004 | 0.0006 | 99.9995 |
| 9 | 1.94e−005 | 0.0002 | 99.9999 |
| 10 | 7.72e−006 | 0.0000 | 100.0000 |

Thus, because the variance beyond component 6 is negligible, EQ 22 can be reduced for low resolution to:

M_{1×30}×Loads^{T}_{30×5}=Comp_{1×5} [EQ 23]

and for high resolution to:

M_{1×30}×Loads^{T}_{30×5}=Comp_{1×6} [EQ 24]

Further, EQ 21, for low resolution, becomes:

M_{1×30}=Comp_{1×5}×Loads_{5×30} [EQ 25]

and, for high resolution, becomes:

M_{1×30}=Comp_{1×6}×Loads_{6×30} [EQ 26]

EQ 23 and EQ 24 indicate that, providing a reduced form of the Loads matrix, the T1 build up of length 30 can be compressed. Further, given a build up of length N, a Loads matrix needs to be created as a 5×N into 1×5 matrix for low resolution and as a 6×N into 1×6 matrix for high resolution. EQ 25 and EQ 26 indicate that the build up can be recovered by using the same model and the corresponding compression. EQ 13 and EQ 14, discussed above with regard to decompression directly into T₂ are applicable, as well, to T₁. That is, with each A value being proportional to the proton population of pores which have a longitudinal relaxation time of T₁, EQ 13 can be used to compress T₁ build up data downhole and, by knowing only the Scores matrix and using the identity matrix I, EQ 14 can be used to decompress compressed echo train or T₁ build up data into a T₂ or T₁ distribution, respectively, without the need to decompress into an echo train or a build up trace first and then invert to get the corresponding distribution.

Based on EQ 14, the direct decompression into T₁ or T₂ domain distribution decreases processing time to determine the property based on the NMR data. The prior art inversion step (to determine T₂ or T₁ distribution) requires exhaustive memory capacity and CPU execution time. On the other hand, compression requires only matrix multiplication, which current digital signal processing (DSP) software, memory, and processor systems execute as a multiply accumulate and round in a single processor instruction of one cycle. Thus, compression (which may take approximately 150 ms, for example) followed by direct decompression into the T₁ or T₂ domain distribution (without additional inversion) saves significant memory and execution time. As noted above, the compression itself allows NMR signals to be conveyed in real time, even with a slow transmission rate technique, such as mud pulsing, for example. Further, decompression into the T₁ or T₂ domain distribution data (rather than the echo train or T1 build up) allows real-time imaging and then determination of the lithology of the formation in real time without reverting to inversion. In addition, the real time reconstruction may be done while drilling or while logging. The determination of lithology may include, for example, integration of distribution data up to a predefined T₂ or T₁ cutoff (e.g., 3.3 millisecond (ms)).

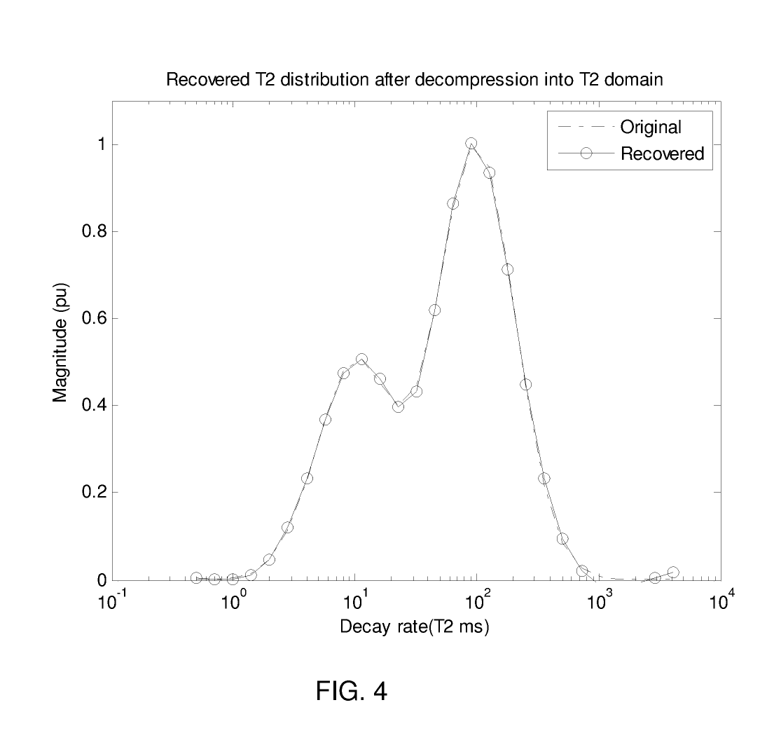

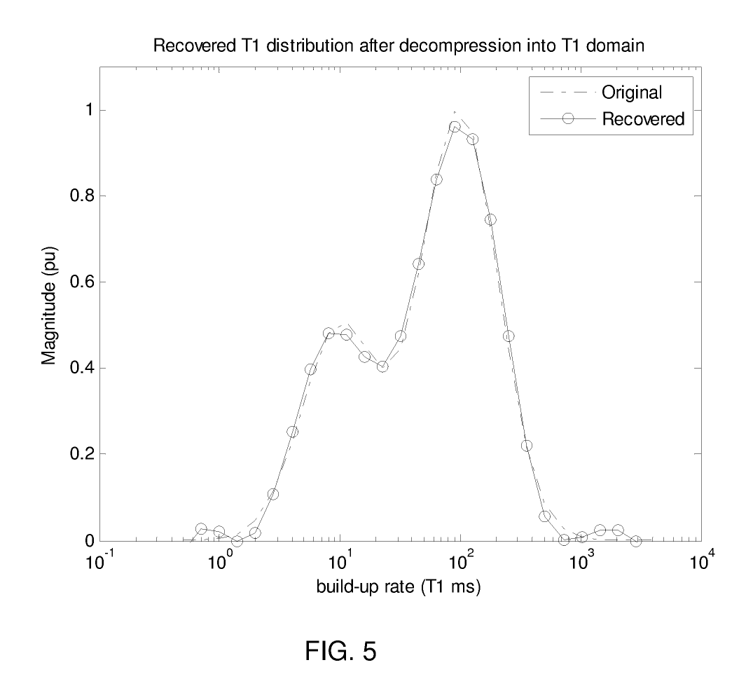

FIG. 4 and FIG. 5 illustrate exemplary T₂ and T₁ domain distribution data, respectively, recovered by direct decompression according to embodiments of the invention. FIG. 4 shows that the recovered T₂ distribution based on direct decompression is essentially a perfect match for the original T₂ distribution that may have been compressed downhole. As FIG. 5 shows, the recovered T₁ distribution based on direct decompression is nearly a perfect match for the original T₁ distribution associated with the compressed NMR signal downhole.

In support of the teachings herein, various analysis components may be used, including a digital and/or an analog system. For example, the downhole electronics 9 or the computer processing system 11 may include the digital and/or analog system. Each system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art.

It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of characterizing a property of an earth formation penetrated by a borehole, the method comprising:
conveying a carrier through the borehole;
performing an NMR measurement with an NMR tool disposed at the carrier and obtaining NMR data;
compressing the NMR data to generate compressed NMR data;
telemetering the compressed NMR data to a surface processor for processing;
decompressing the compressed NMR data directly to T₁ or T₂ domain distribution data; and
determining the property of the earth formation based on the T₁ or T₂ domain distribution data.

2. The method according to claim 1, wherein the determining the property includes determining a lithology of the earth formation.

3. The method according to claim 1, wherein the determining the property is in real time.

4. The method according to claim 3, wherein the determining the property is done during drilling.

5. The method according to claim 3, wherein the determining the property is done during logging.

6. The method according to claim 1, wherein the NMR data represents an echo train sequence.

7. The method according to claim 1, wherein the NMR data represents T₁ data.

8. The method according to claim 1, wherein the decompressing the NMR data directly to the T₁ or T₂ domain distribution data is according to:
Comp_{1×m}×Scores_{k×m}^{t}×(Scores_{k×m}×Scores_{k×m}^{t})⁻¹=A_{1×k}×I_{k×k}
where Comp is the compressed NMR data,
A represents the T₁ or T₂ domain distribution data,
I is an identity matrix, and
Scores are scale vectors of each Principle Component, based on orthogonal decomposition), of a matrix that spans all single component decays in an echo train space of the NMR data.

9. A system to characterize a property of an earth formation penetrated by a borehole, the system comprising:
an NMR tool disposed in the borehole and configured to perform an NMR measurement to obtain NMR data;
a first processor configured to compress the NMR data to generate compressed NMR data; and
a second processor disposed at an uphole location, the second processor configured to receive the compressed NMR data and decompress the compressed NMR data directly to T₁ or T₂ domain distribution data and characterize the property of the earth formation based on the T1 or T2 domain distribution data.

10. The system according to claim 9, wherein the second processor characterizes lithology of the earth formation based on the T1 or T2 domain distribution data.

11. The system according to claim 9, wherein the NMR data represents an echo train sequence.

12. The system according to claim 9, wherein the NMR data represents T₁ data.

13. The system according to claim 9, wherein the second processor characterizes the property of the earth formation in real time.

14. The system according to claim 13, wherein the second processor characterizes the property of the earth formation during drilling.

15. The system according to claim 13, wherein the second processor characterizes the property of the earth formation during logging.

16. The system according to claim 9, wherein the second processor decompresses the compressed NMR data according to:
Comp_{1×m}×Scores_{k×m}^{t}×(Scores_{k×m}×Scores_{k×m}^{t})⁻¹=A_{1×k}×I_{k×k}
where Comp is the compressed NMR data,
A represents the T₁ or T₂ domain distribution data,
I is an identity matrix, and
Scores are scale vectors of each Principle Component, based on orthogonal decomposition, of a matrix that spans all single component decays in an echo train space of the NMR data.

17. A computer-readable medium configured to store instructions which, when processed by a processor, cause the processor to perform a method of characterizing a property of an earth formation penetrated by a borehole, the method comprising:
receiving compressed NMR data generated by compressing NMR data obtained by an NMR tool disposed at a carrier conveyed through the borehole;
decompressing the compressed NMR data directly to T₁ or T₂ domain distribution data according to:
Comp_{1×m}×Scores_{k×m}^{t}×(Scores_{k×m}×Scores_{k×m}^{t})⁻¹=A_{1×k}×I_{k×k}
where Comp is the compressed NMR data,
A represents the T₁ or T₂ domain distribution data,
I is an identity matrix, and
Scores are scale vectors of each Principle Component, based on orthogonal decomposition), of a matrix that spans all single component decays in an echo train space of the NMR data; and
determining the property of the earth formation based on the T₁ or T₂ domain distribution data.

18. The computer-readable medium according to claim 17, wherein the determining the property is in real time.

19. The computer-readable medium according to claim 18, wherein the determining the property is during drilling.

20. The computer-readable medium according to claim 18, wherein the determining the property is during logging.
